(19) United States
(12) Patent Application Publication
(10) Pub. No.: US 2002/0041650 A1
(43) Pub. Date: Apr. 11, 2002

(54) Elastic serial buffer to compensate for different transmit and receive clock rates for any serial protocol

(76) Inventor: Scott Edward Richmond, Boulder, CO (US)

Correspondence Address: FALK AND FISH, 16590 OAK VIEW CIRCLE, MORGAN HILL, CA, 95037, US

(21) Appl. No.: 09/903,147

(22) Filed: Jul. 10, 2001

Related U.S. Application Data
(60) Provisional application No. 60/217,520, filed on Jul. 11, 2000.

(51) Int. Cl. H04L 7/00

(52) U.S. Cl. 375/372

(57) ABSTRACT

An elastic buffer structure and process to avoid overflow or underflow in serial protocol communications using spread spectrum transmit and receive clocks or other separate transmit and receive clocks which may be running at different frequencies. Overflow and underflow are averted by storing received data in a FIFO at different addresses using a receive address pointer incremented at a receive clock rate. Other circuitry senses which addresses have nonessential primitives or nonessential data that can be deleted. Data is transmitted out of the FIFO at a transmit clock rate using a transmit address pointer incremented at the transmit clock rate. Control logic compares the transmit pointer to the receiver pointer, and when the distance between the pointers becomes too large or two small, inserts additional nonessential primitives or nonessential data or deletes nonessential primitives or nonessential data so as to maintain the distance between the pointers at a constant, selected value.

### BACKGROUND OF THE INVENTION

This is a continuation-in-part of a prior filed provisional application entitled Serial Protocol Elastic Buffer, filed Jul. 11, 2000, Ser. No. 60/217,520, which is hereby incorporated by reference.

Serial communications systems typically consist of a transmitter and a receiver at each end of the communications medium. The transmitter at one end of the link is coupled by a transmission medium to the receiver at the second end of the link and the transmitter at the second end of the link is coupled by a transmission medium to the receiver at the first end of the link, as shown in FIG. 1. There is circuitry 10 at the second end of the link to which the transmitter and receiver at the second end of the link are coupled that processes received data from receiver 16 and provides data to be transmitted to transmitter 18. In the prior art, there were two distinct sections of this circuitry. One section, 12, receives data from the receiver 16 and operates at a clock rate of the receive clock extracted by receiver 16 from the transmitted data on medium 20. Circuitry 14 operates on a different transmitter clock at the rate transmitter 18 transmits data and typically reacts to data received by receiver 16 by transmitting other data using transmitter 18. Thus, there is duplicate logic.

Because these clocks can have slightly different rates, there are underflow and overflow issues in transferring of information between circuitry 12 and circuitry 14. Specifically, because of the difference in frequency, the transmit side 14 will see either one character for two clocks or portions of two characters in one clock period unless some additional clock synchronization logic 22 is used. The goal is for both the circuits 12 and 14 to be able to use and understand the characters to or from the other side.

Synchronization circuitry 22 couples circuitry 12 to circuitry 14 and synchronizes data flow between the circuitry to remove the problems caused by the different clock rates. This problem is aggravated by the use of spread spectrum clocks where the frequency of each of the transmit and receive clocks is continuously varied independently to aid in reduction of electromagnetic interference. If the synchronization circuitry 22 is not used, an event that lasts for one clock cycle of the A clock that needs to be sent from circuit 12 to circuit 14 can, on occasion, be missed by circuit 14 if the transmit clock used by circuit 14 has a longer period than the receive clock used by circuit 12.

The fact that two different sets of circuits 12 and 14 plus synchronization circuitry needs to be used in the prior art to handle the processing of data by the second end of the link and this same set of circuits also needs to be instantiated at the first end of the link causes the transmission circuitry to be more expensive than necessary.

It is believed by the applicant that at least some Fibre Channel systems made by Vitesse have used a similar concept as is used in the invention in one mode of operation. In this mode of operation, multiple K28.5 primitives have been injected seriatem in order to allow some primitives to be deleted or more to be added to account for clock slip. The Vitesse system does this only when there are multiple serial channels all transmitting in the same direction, each carrying part of the data so that segmentation and reassembly of the data from the different wires is necessary at the other end. The inserted primitives are to maintain synchronization between the different channels going in the same direction. This does not work for serial ATA protocols which is the protocol frequently used for communication with disk drives.

Because of the difference in clock rates, unless some compensation is made, if the receive clock is higher in frequency than the transmit clock, then more characters will be received than are sent and an overflow of the available buffer space will eventually occur. If the transmit clock is higher in frequency than the receive clock, more characters are being transmitted over any particular interval than are being received, and an underflow will occur where the transmitter runs out of data. Either underflow or overflow will cause loss of control characters or user data and cause an error in the system.

Thus, a need has arisen for a method and apparatus to reduce the complexity of the circuitry at each end of a serial protocol link to compensate for drift between the frequencies of the transmit and receive clocks.

### SUMMARY OF THE INVENTION

The invention is an elastic buffer which inserts and deletes primitives in the data stream between the receiver and the circuitry shared between the receiver and transmitter to prevent overflow or underflow. The primitives are inserted or deleted as needed from the data stream from the receiver to the shared circuitry to compensate for clock drift. This is done by using several different logic circuits. A first circuit stores the incoming data stream at the receive clock rate and transmits it at the transmit clock rate. A second circuit compares the incoming data to the bit pattern of the primitive or primitives, or other nonessential data that can be inserted or deleted at will without causing unintended results and tells a third circuit where the primitive or other non essential data is in the first circuit buffer. A third circuit determines when a primitive or other non essential data is present which can be deleted and compares the receive address (referred to in the claims as a receive address pointer) to the transmit address (referred to in the claims as a transmit address pointer). When there is a possibility of overflow or underflow, the appropriate control signal to a transmit clock address generator is generated to cause one or more primitive or other non essential data to be inserted or deleted appropriately to compensate for the difference in clock rates and prevent any underflow or overflow.

Alternatively, the primitives or other non essential data can be inserted or deleted from the stream between the shared circuitry and the transmitter at the second end of the link.

The primitives, or other non essential data, that are inserted and deleted can be any character or other non essential data that is inconsequential to the serial protocol in use for the link between the receiver and the shared circuitry such as, but not limited to, any defined no op primitive or any other character that will not cause any unintended actions in the shared circuitry of transmitter or receiver and will not cause the system to operate improperly. In the case of serial ATA protocol, the primitive used is the align primitive.

Any circuitry to detect the drift and insert or delete a sufficient number of non essential characters to compensate for the drift will suffice to practice the invention. The invention allows the circuitry coupled to both the transmitter and receiver to receive data from the receiver, process it or react to it and provide data to the transmitter to work on only one clock thereby eliminating the need for

The invention applies to any serial protocol transmission circuitry.

### BRIEF DESCRIPTION OF THE DRAWINGS

FIG. 1 is a diagram of a typical prior art serial communication setup.

FIG. 2 is a diagram of an improved serial communication system utilizing an elastic buffer according to the teachings of the invention.

FIG. 3 is a block diagram of one species of elastic buffer within the genus of the invention.

FIGS. 4A, 4B and 4C are diagrams illustrating how the elastic buffer changes the content of the data stream, and specifically, the number of align primitives to correct for clock slip.

FIG. 5 is a diagram illustrating the logic of the primitive insertion/deletion logic.

FIGS. 6A through 6D are a flowchart of a process according to the teachings of the invention.

FIG. 7 is a diagram of the different comparison functions the insert/delete logic performs.

### DETAILED DESCRIPTION OF THE PREFERRED EMBODIMENT

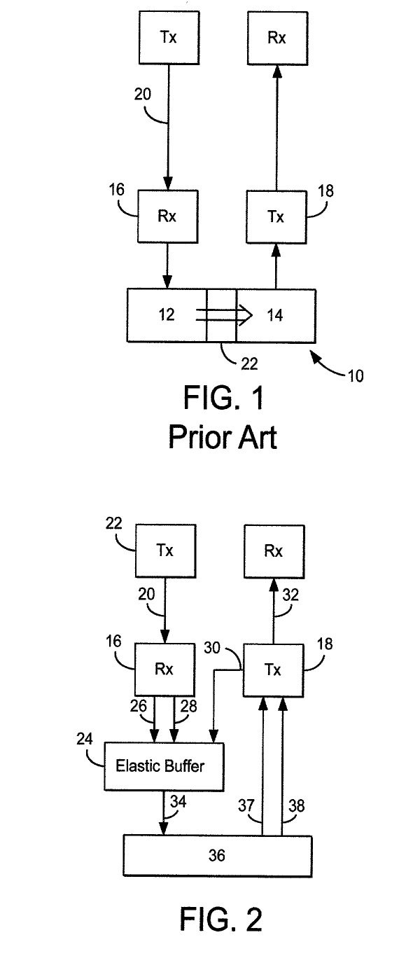

Referring to FIG. 2, there is shown a diagram of an improved serial communication system utilizing an elastic buffer according to the teachings of the invention. Transmitter 22 transmits serial format data over link 20 to receiver 16 which has the same structure as receiver 16 in FIG. 1. Receiver 16 extracts a receive clock from the data received from line 20 and provides this receive clock to an elastic buffer 24 on line 26 along with the recovered data on line 28. The elastic buffer 24 receives data on line 28 at the receive clock rate. In alternative embodiments, the elastic buffer could be placed in line 38 instead of the position shown in FIG. 2. In general, the elastic buffer is between the PHY and receive link layers and serves to detect overflow or underflow, and resynchronize the receive data to the transmit clock by inserting or deleting align primitives or other non essential characters as necessary to prevent overflow or underflow. Hereafter, the non essential primitives or other non essential characters will simply be referred to as primitives. Any logic that can do this will suffice to practice the invention. Detection of overflow or underflow may be performed in many ways.

The elastic buffer also receives a transmit clock on line 30. This transmit clock is the same clock used by transmitter 18 to transmit data on medium 32. The elastic buffer serves to insert or delete primitives as needed to compensate for drift between the receive clock and the transmit clock so as to output data on line 34 at the transmit clock rate. circuitry 36 does whatever processing is necessary on the received data and transmits data on line 38 at the transmit clock rate to transmitter 18 for transmission on medium 32. Circuit 36 operates at the transmit clock and supplies that transmit clock on line 37 to the transmitter 18.

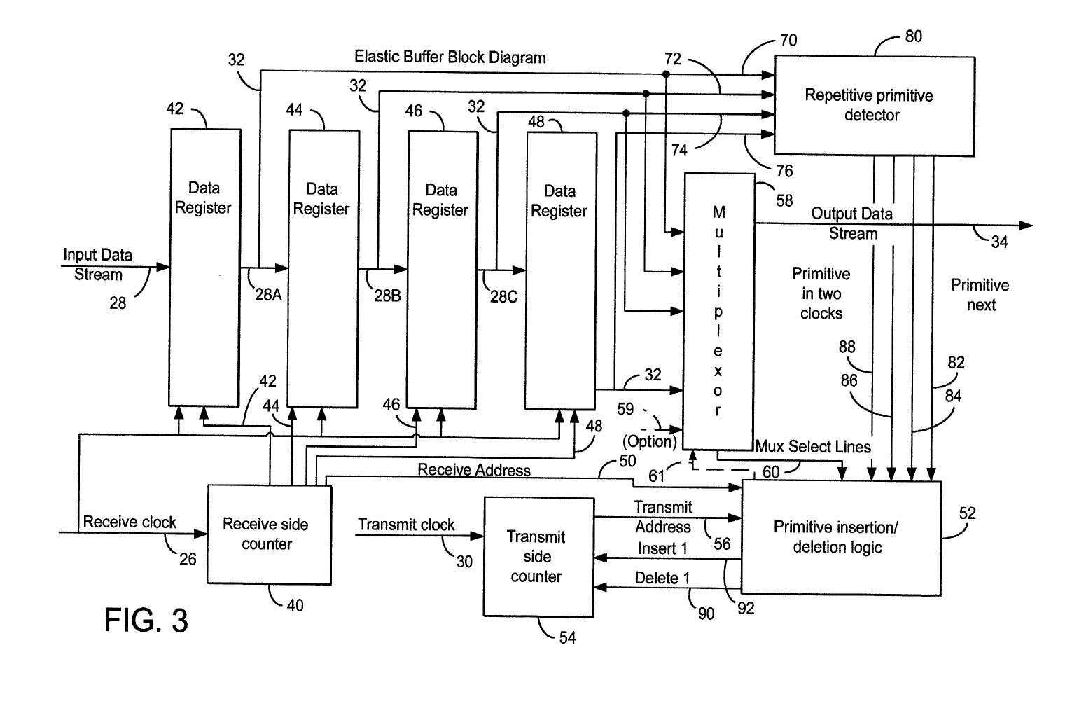

Referring to FIG. 3, there is shown a block diagram of one embodiment of the elastic buffer 24. Input data arrives on line 28 from the receiver 16 and is in the format of 4 8-bit bytes per 32 bit word. Output data to circuitry 36 in FIG. 2 is supplied via line 34 and is clocked out of the elastic buffer FIFO at the frequency of the transmit clock received on line 30 from the transmitter. This data is actually coupled by bus segments 28A, 28B and 28C simultaneously to all the inputs of data registers 42, 44, 46 and 48. Each 32 bit data word or 32 bit primitive that arrives on bus 28 will be deposited in only one of data registers 42, 44, 46 and 48, as determined by the address generated by receive side counter 40.

In the embodiment of FIG. 3, only four registers are shown, but in the preferred embodiment 6 to 8 data registers are used. The need for multiple registers arises from the delay caused by the circuitry to be described below which is used to recognize which register contains a primitive and when clock slip has occurred beyond the allowed amount. Since this processing cannot be accomplished instantaneously, it is necessary to be able to store an adequate number of incoming words and primitives while this processing is happening until a decision to add or subtract one or more primitives is being made to keep the output in synchronization with the input. The minimum number of data storage registers that can be used is the number needed to store the maximum of amount of data that can accumulate caused by the maximum amount of clock slip that can occur in the 256 data word interval between align characters on line 20 in FIG. 2. Theoretically, if instantaneous decisions were possible, only two registers could be used in the register array 42, 44, 46 and 48. The two extra registers in FIG. 3 are necessary to provide sufficient time to make the decision, and provide synchronization time for the data between the transmit and receive clock, preventing simultaneous writing and reading from the same register which can cause metastability problems.

The receive clock is received from the receiver 16 on line 26. The receive clock increments a receive side counter 40 so as to cause it to increment once for each 32 bit word. The receive side counter cycles through addresses 0, 1, 2 and 3 as it increments corresponding to activation of a chip select signal on lines 42, 44, 46 and 48, sequentially. This causes each sequence of 32-bit words or primitive that arrives to be deposited one-by-one in data registers 42, 44, 46 and 48, respectively on 4 successive increments of counter 40.

The receive address generated by the receive side counter 40 is also supplied via line 50 to primitive insertion/deletion logic 52 for purposes of detecting clock slip. To detect clock slip, the insertion/deletion logic 52 must also receive the transmit address. The transmit address is generated by a transmit side counter 54 and is supplied to the insertion/deletion logic on line 56. The transmit side counter increments between addresses 0, 1, 2 and 3 on every cycle of the transmit clock on line 30.

The outputs of each of data registers 42, 44, 46 and 48 are coupled to inputs of a multiplexer 58. The output of this multiplexer is output data line 34. Control over which input is coupled to output line 34 is provided by the MUX Select signal on line 60 which is basically the transmit address on line 56 passed through insertion/deletion logic 52 and output on line 60. Thus, the transmit address on line 56 controls which of the registers 42, 44, 46 and 48 has its contents supplied to the output data stream 34.

The outputs of each data register are each coupled via lines 70, 72, 74 and 76 to a comparator 80. The comparator has internal thereto a hardwired reference bit pattern for the primitive in use by the invention to compensate for clock slip. This reference bit pattern is constantly compared to the bit patterns on each of lines 70, 72, 74 and 76. The comparator has four output lines 82, 84, 86 and 88. Each of these corresponds to one of registers 42, 44, 46 and 48. When one of registers 42, 44, 46 or 48 contains the align primitive or whatever other primitive is being used, comparator 80 activates the corresponding one of lines 82, 84, 86 or 88 to inform the insertion/deletion logic 52 which of the registers contains the primitive being used to manage clock slip. If more than one register has a primitive stored therein that can be deleted, the comparator 80 will activate the lines 82, 84, 86 or 88 that correspond to the registers that are storing deletable primitives. In alternative embodiments, the comparator 80 compares the bit patterns on lines 70, 72, 74 and 76 to the bit patterns of all non essential primitives or other non essential characters that can be deleted, and activates one or more of lines 82, 84, 86 and 88 to indicate which registers contain non essential primitives or other non essential data that can be deleted if necessary. In the preferred embodiment, the bit patterns on lines 70, 72, 74 and 76 are all simultaneously compared to the reference bit pattern. In alternative embodiments, the bit patterns on lines 70, 72, 74 and 76 are all simultaneously compared to all the reference bit patterns of primitives that can be deleted. In still other alternative embodiments, the bit patterns of the data on lines 70, 72, 74 and 76 are all compared to the reference bit pattern(s) of the non essential primitives or other non essential data that can be deleted one at a time, but since this takes more time to find one or more registers with non essential primitives or other non essential data that can be deleted, it is possible more registers would have to be used.

The purpose of the insertion/deletion logic 52 is to compare the receive address with the transmit address and make decisions to insert or delete primitives such that the transmit address is always within two addresses of the receive address for a four register implementation. The two address differential is an arbitrary number and any other number could have been picked. For example, with six registers, a differential of three could be used, and with seven registers, a differential of either three or four could be used. The point is that the insertion/deletion logic maintains a constant difference between the receive address and the transmit address as the frequencies of the transmit and receive clocks drift or are changed relative to each other. This is done by selectively inserting and deleting primitives. This done by deleting a primitive by activating the Delete 1 signal on line when the distance between the transmit and receive addresses becomes more than two, and by inserting a primitive by activating the signal Insert 1 on line 92 when the distances between transmit and receive addresses become less than two. When Delete 1 is active, the transmit address counter 54 increments by two instead of one when it reaches the address of the data register containing the primitive or other non essential data thereby skipping output of the content of that register. When Insert 1 is activated, the transmit side counter 54 is caused to not increment one time when the address of the data register containing the primitive is reached. This causes the primitive to be output for two consecutive clock cycles thereby inserting an extra primitive. In an alternative embodiment, the multiplexer 58 can have an extra input 59 which is hardwired to the bit pattern of the primitive to be inserted. In this alternative embodiment, the insertion/deletion logic 52 supplies the Insert 1 signal as a switching control signal on line 61 to the multiplexer 58 to cause it to switch so as to couple line 59 to output stream 34 for one clock cycle thereby inserting one additional primitive.

Basically, the two counters 40 and 54 controlling data flow through the registers and the multiplexer 58 and the primitive insertion/deletion logic 52 try to maintain a relationship of maximum distance/2. By doing this, the data to the transmit clock always has more than one clock of setup and hold time thereby preventing metastability problems.

Because the two counters are being clocked at different rates, after a period of time, the maximum distance/2 relationship will no longer hold and an adjustment must be made. If the transmit clock is faster than the receive clock, then the distance between the transmit and receive clocks will be maximum distance/2+1. When this condition occurs, the next repetitive primitive detected in the data register is duplicated in the output stream by not incrementing the transmit side counter 54 when the register holding the primitive is coupled to the output stream so that the primitive is transmitted twice during consecutive clock cycles. If the receiver is faster than the transmitter, the distance will equal maximum distance/2−1, and an adjustment must again be made to delete a primitive from the data stream. This is done by detecting the condition when the next word in the output data stream is scheduled to be the primitive and causing the transmit side counter to increment by two to skip over the register containing the primitive. This deletes the primitive.

It is important that the FIFO be deep enough that when the conditions exist that will cause insertion or deletion of the primitive, the distance between the transmit and receive addresses still be at least two. This is to guarantee no metastability problems with data held in a register clocked by the receive clock going to a register that is clocked by the transmit clock. If the FIFO is large enough, the same general concept described herein can be used to insert or delete multiple primitives simultaneously.

More precisely, the insertion and deletion logic 52 compares the transmit and receive addresses at all times. When the distance between the transmit and receive addresses becomes greater than two, a delete flag (not shown) gets set. When the distance between the transmit and receive addresses becomes less than two, an insert flag (not shown) gets set. These flags essentially arm the insertion and deletion logic to either delete or insert a primitive. The actual insertion or deletion of a primitive does not happen until a primitive arrives and has been stored in one of the registers 42, 44, 46 or 48. When one or more primitives arrives, comparator 80 detects this fact and activates the appropriate one or more of the lines 82, 84, 86 or 88. The insertion/deletion logic then activates the appropriate one of the Insert 1 or Delete 1 signals.

When the Delete 1 signal is activated, the transmit side counter skips over the address of the data register in which the primitive is stored. In other words, if the primitive is stored in register 46 which has address 2, the transmit side counter will increment as follows: 0, 1, 3, 0, 1, 2, 3 . . . . Thus, address 2 will be skipped over one time in a cycle through all the addresses of the data registers. This causes the contents of register 42 to be applied to line 34, then the contents of register 44 will be applied to line 34. Then register 46 is skipped over and the contents of register 48 are applied to line 34. Then, the process starts over with the contents of registers 42, 44, 46 and 48 being applied to line 34 in that order.

When the Insert 1 signal is activated, the transmit side counter will stay on the address where the primitive is stored for two clock cycles thereby adding a primitive. For example, if the primitive is stored in address 2, incrementation of the transmit side counter would go as follows: 0, 1, 2, 2, 3, 0, 1, 2, 3 . . . . Thus, address 2 would be maintained for two consecutive clock cycles to insert an additional primitive. This means that the contents of register 42 will first be applied to line 34, and then the contents of register 44 are applied to line 34. Then, the contents of register 46 will be applied to line 34 for one clock cycle and then applied to line 34 again during the next clock cycle. Then the contents of register 48 will be applied to line 34, and the process starts over with the contents of register 42.

In serial ATA protocol and fibre channel protocols, a primitive called K28.5 is used as a special control character defined in these specifications. The K28.5 primitive is a block of data with an intentional run length violation which allows the physical layer circuitry to maintain clock synchronization. This primitive is sent aligned with 32-bit word boundaries and allows the physical layer circuitry to stay aligned on the 8-bit boundaries of the 8b/10b encoded data. The K28.5 primitive causes a run length violation on an 8-bit boundary so the physical layer circuitry can tell where that boundary is in the stream. The other 8-bit boundaries are found just by counting bits after the run length violation primitive.

Although this K28.5 primitive could be used as the primitive to be inserted and deleted to account for clock slip, the actual primitive used in the serial ATA protocol is the align primitive. The align primitive has no purpose in the communications on line 34 in FIG. 3, and the protocol does not care what the spacing is between align primitives on line 34. Therefore, any other primitive that has no purpose in the data stream on line 34 could also be used since the protocol ignores these primitives. The align primitive was chosen because it is guaranteed in the serial ATA protocol to be sent repetitively in the communications on line 20 so it can be inserted and deleted at will on line 34 to compensate for clock slip. In other words, the align character is transmitted every 256 data words on line 20 to maintain the receiver 16 in synchronization. It can be inserted and deleted at will on line 34 without causing any problems.

The apparatus of the invention is especially useful in systems which transmit serial protocol data using spread spectrum clocks on both the transmit and receive side. These clocks have their frequencies changed on a linear function first increasing to a certain maximum frequency linearly from a starting frequency and then linearly decreasing over time back to the starting frequency. There is a maximum difference between frequency in the transmitter and receiver of 0.5% in these systems. This maximum frequency difference translates to one bit shift every 200 bits which translates to one 40-bit align primitive every 8000 clock cycles. Currently, the align primitives are transmitted every 10240 clocks maximum. However, if spread spectrum clocking is to be used, the elastic buffer of the invention must be used to insert align primitives more often to maintain synchronization.

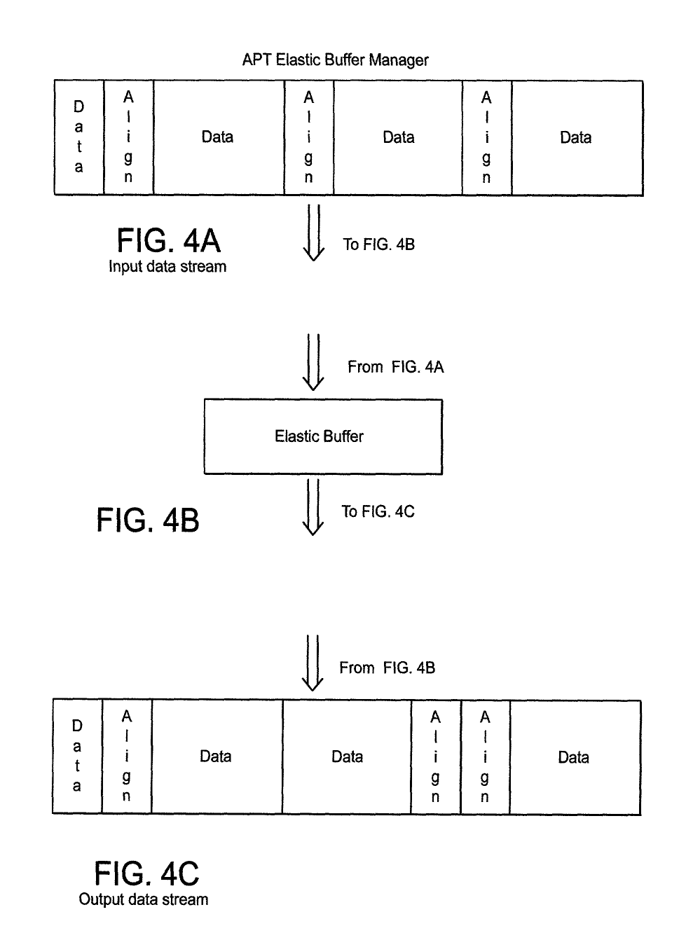

Referring to FIGS. 4A, 4B and 4C, there is shown a symbolic description of the input data stream (FIG. 4A) to the elastic buffer (FIG. 4B) and the output data stream (FIG. 4C) shown how more align primitives have been added to correct for clock slip.

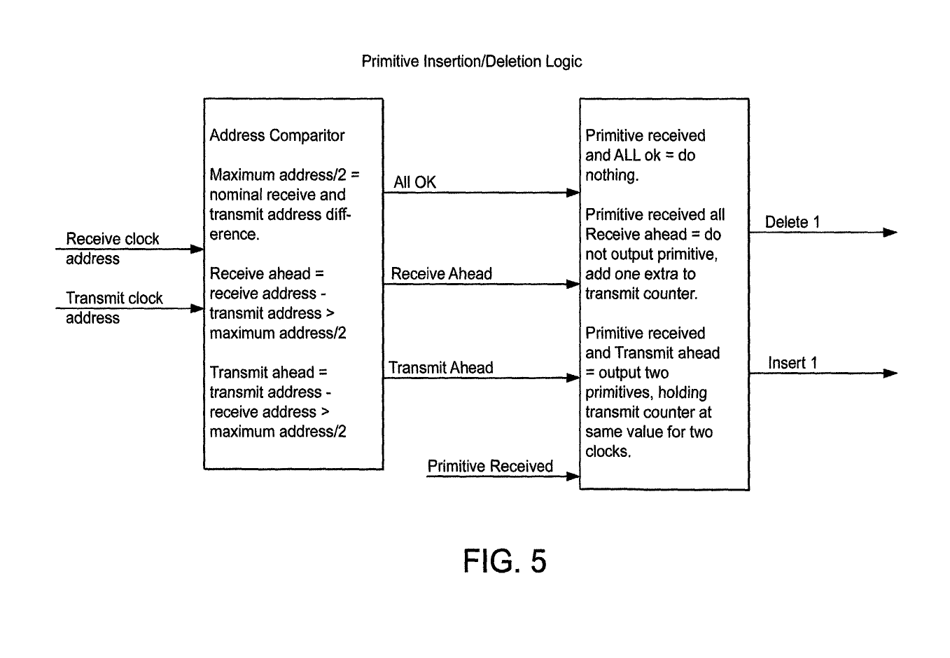

FIG. 5 is a diagram of the logic of the primitive insertion/deletion logic showing how the insertion/deletion logic 52 reacts to the receive address being ahead of the transmit address and vice versa.

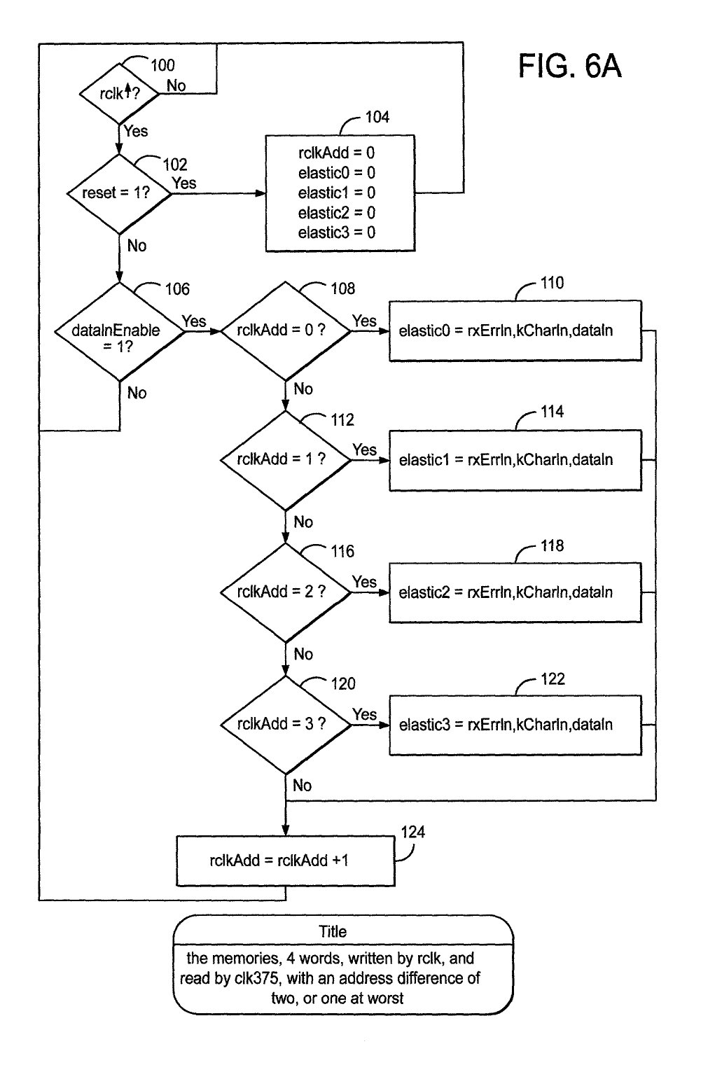

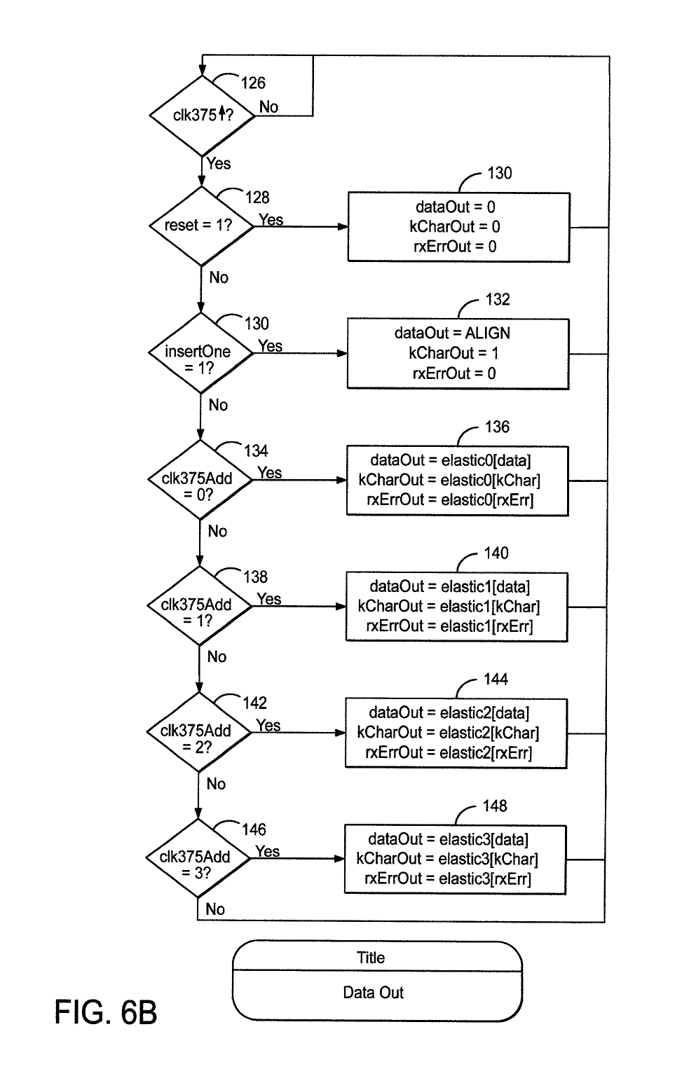

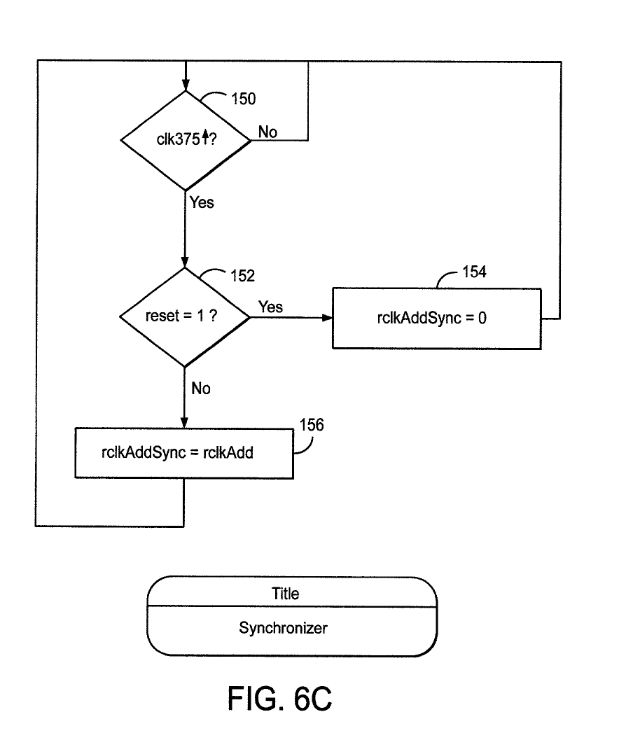

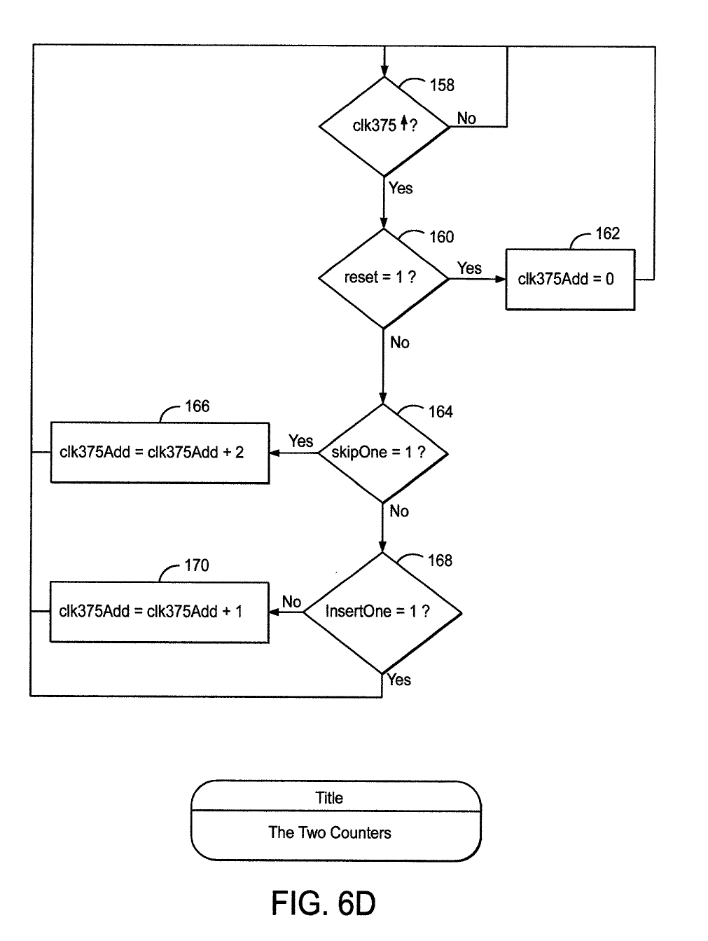

Referring to FIGS. 6A through 6D, there is shown a flowchart of a process according to the teachings of the invention. Steps 100, 102 and 104 determine if a reset condition exists and, if so, on a rising edge of the receive clock on line 26 in FIG. 3, the contents of the data registers 42 through 48 are set to zero as is the count of counter 40.

Step 106 determines if the data in strobe has occurred. The receive clock on line 26 is a byte clock, but a complete data word is 4 bytes, so a data in strobe is generated every 4 byte clock cycles on line 26. Steps 108, 110, 112, 114, 116, 118, 120, 122 and 124 serve to write the data word existing at input line 28 into the appropriate one of the data registers 42, 44, 46 or 48 pointed to by the address output by the receive side counter 40. Step 124 increments the receive clock address on ine 50 by one, and the process then starts over with step 100.

Steps 126, 128 and 130 determine if a reset condition has been set, and, if so, upon a rising edge of the transmit clock clk375, resets the system and controls the multiplexer so that the data output stream is all zeroes. Step 132 determines if the Insert 1 signal is active, and, if so, controls multiplexer 58 to insert an additional primitive. This is done in any way, including controlling the multiplexer to select as an input a hardwired primitive bit pattern for coupling to line 34. Steps 134, 136, 138, 140, 142, 144, 146 and 148 all cooperate to control the switching control signal on line 60 so as to select as an input for coupling to line 34 the input coupled to the output of the data register pointed to by the transmit address generated in transmit side counter 54.

Steps 150, 152, 154 and 156 serve to synchronize the application of the receive address on line 50 to the transmit clock on line 30 internally to the insertion/deletion logic 52 so that the distance between the transmit and receive addresses can be effectively compared. The insertion/deletion logic runs on the transmit clock on line 30 so the receive address on line 50 and the transmit address on line 56 must be applied to a comparator internal to the insertion/deletion logic 52 synchronously using the same clock to avoid metastability problems. That is the function of the routine of FIG. 6C to make sure that happens by reading the receive address 50 at the rising edge of the transmit clock 30.

Steps 158, 160 and 162 serve to determine if the reset button has been pushed, and, if so, on the rising edge of the transmit clock to reset transmit side counter address, called clk375Add in the flowchart, to zero. Steps 164 and 166 serve to determine if the Delete 1 (called skipOne in the flowchart) is active, and, if so, to set the value of a register or accumulator clk375Add to the old value of the clk375Add plus 2. In other words, if Delete 1 is active, the transmit side counter address, clk375Add, is incremented by two instead of one at the next rising edge of the transmit side clock. Steps 168 and 170 determine if the Insert 1 signal is active, and, if not, step 170 does the normal incrementation of the transmit side counter address by one. If step 168 determines that the Insert 1 signal is active, step 170 is skipped, so the transmit side counter address remains the same for another transmit clock cycle thereby causing an additional primitive to be inserted.

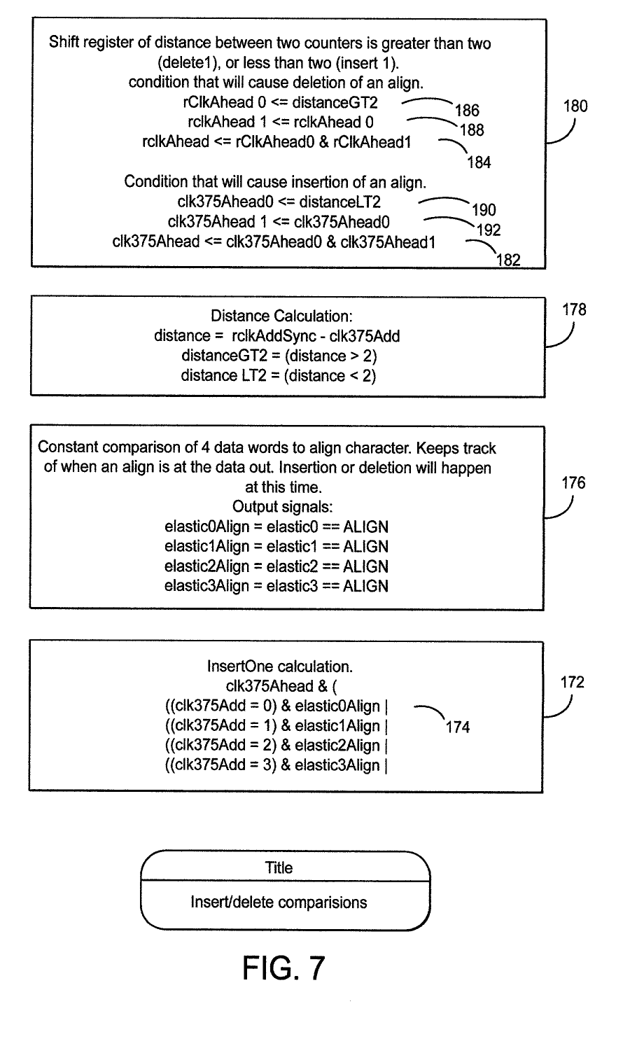

Referring to FIG. 7, there is shown the various comparisons and calculations that must be done by the insert/delete logic 52. Any logic or programmed computer that can perform these comparisons and calculations will suffice to practice the invention. The calculations in box 172 are the calculations that are performed by the insertion/deletion logic to determine when to activate the Insert 1 signal on line 92. The variable clk375Ahead is a flag which is set whenever the transmit clock is running faster than the receive clock and a primitive must be inserted for synchronization. There are four calculations which are performed which are basically performed to determine when to activate the Insert 1 primitive. The Insert 1 signal will be activated when the clk375Ahead flag is set and the transmit side address clk375Add is 0 and the signals on lines 82, 84, 86 and 88 indicate that the align primitive is in the data register that corresponds to address 0. That is the meaning of the notation on line 174. Likewise, the other three calculations will activate the Insert 1 signal whenever the clk375Ahead flag is set and the align primitive is resident in the data register currently pointed to by the transmit address.

There is a similar calculation for the Delete 1 signal but the precondition is that an rclkahead variable or flag must be set indicating the receive clock is running faster than the transmit clock and a primitive must be deleted in order to compensate for clock slip.

The calculations in block 176 represent the comparison processing that is performed in comparator 80 of FIG. 3 to constantly compare the contents of each data register to the bit pattern of the align primitive. Any data register which has the align primitive in it will cause the elasticXAlign signal to go active where X designates the address of the register containing the align primitive.

The calculations in block 178 represent the distance calculations where the transmit address is compared to the receive address. The flag distanceGT2 is set when the distance between the addresses is greater than 2, and the flag distanceLT2 is set when the distance is less than 2.

The calculations in block 180 are the calculations that are performed by the insertion/deletion logic of the conditions that will set the clk375Ahead flag used as the precondition in the calculations of block 172 to insert a primitive and to set the rclkAhead flag used as preconditions to the calculations to delete a primitive. The calculations at 182 and 184 make sure that only one primitive is inserted at a time and only one primitive is deleted at a time, respectively. The calculations at lines 186 and 188 define the conditions when the rclkAhead flag will be set or not set. The calculations at lines 190 and 192 define the conditions when the clk375Ahead flag will be set and not set.

Although the invention has been disclosed in terms of the preferred and alternative embodiments disclosed herein, those skilled in the art will appreciate that modifications and improvements may be made without departing from the scope of the invention. All such modifications are intended to be included within the scope of the claims appended hereto.

What is claimed is:

1. An apparatus comprising:
a data input;
a data output;
a multiplexer have a plurality of inputs and an output coupled to said data output, and having a control input for receiving a switching control signal;
a comparator having a plurality of data inputs and having a reference bit pattern, and having one primitive present output corresponding to each data input, said comparator functioning to compare the data at each input to said reference bit pattern and activate a primitive present signal on the output corresponding to each of said data inputs at which data appears which matches said reference bit pattern;
a plurality of data registers having data inputs coupled to said data input, each said data register having a data output coupled to one of said inputs of said multiplexer, and to one of said inputs of said comparator, each said data register having an address input for receiving a select input signal, which when active, will cause said data register to store the data then existing on said data input;
a receive clock input for receiving a receive clock signal;
a transmit clock input for receiving a transmit clock signal;
an insertion/deletion control unit having a plurality of inputs coupled to receive said primitive present signals from said comparator, and having a transmit address input for receiving a transmit address signal and a receive address input for receiving a receive address signal, and having a switching control output coupled to supply said switching control signal to said control input of said multiplexer, and having a delete output at which a Delete signal appears, and having an insert output at which an Insert signal appears, and having logic for comparing a transmit address to said receive address and activating said Delete signal when the difference between said transmit address and said receive address is greater than the number of data registers divided by two, and for activating said Insert signal when the difference between said transmit address and said receive address is less than the number of data registers divided by two, said transmit address controlling which of said outputs of said data registers is coupled through said multiplexer to said data output, and said receive address controlling which of said data registers stores the data currently at said data input;
a receive address counter having a clock input coupled to said receive clock signal and having an address output coupled to each of said address inputs of said plurality of data registers for generating said select input signals for said data registers in sequence as said receive clock increments, and having receive address output coupled to said receive address input of said insertion/deletion control unit to supply said receive address signal thereto;
a transmit address counter having a clock input coupled to receive said transmit clock signal, and having a transmit address output coupled to said transmit address input of said insertion/deletion logic to supply said transmit address signal to said insertion/deletion logic for supplying by said insertion/deletion logic to said multiplexer as said switching control signal, and having an input for receiving a Delete signal and an input for receiving an Insert signal, said transmit address counter configured skip the address in the sequence of address incrementations that corresponds to the address of the data register in which a deletable primitive is stored when said delete signal is activated and configured to dwell on the address that corresponds to the address of the data register in which a deletable non essential primitive or other non essential data is stored for at least one extra clock cycle of said transmit clock when said Insert signal is activated.

2. An apparatus comprising:
means for receiving at a receive clock rate a stream of serial format data including data words and primitives which can be deleted without adverse effects, hereafter called nonessential primitives, and/or other nonessential data and storing said received data in a first in, first out buffer, each data word, primitive and piece of nonessential data stored at a different address;
means for transmitting at a transmit clock rate the data words, primitives and nonessential data stored in said FIFO at selected addresses;
means for determining which addresses in said FIFO store primitives or nonessential data that can be deleted;
means for comparing a transmit address pointer in said FIFO which is incremented at said transmit clock rate to a receive address pointer in said FIFO which is incremented at said receive clock rate and, when the distance between said pointers indicates the possibility of overflow or underflow, controlling said means for transmitting so as to insert nonessential primitives or other nonessential data or to delete nonessential primitives or other nonessential data appropriately to avert either overflow or underflow.

3. A process for preventing overflow or underflow in serial data transmission protocols with separate transmit and receive clocks which may be running at different frequencies, comprising the steps of:
receiving at a receive clock rate a stream of serial format data including data words and primitives which can be deleted without adverse effects, hereafter called nonessential primitives, and/or other nonessential data and storing said received data in a first in, first out buffer, each data word, primitive and piece of nonessential data stored at a different address;
transmitting at a transmit clock rate the data words, primitives and nonessential data stored in said FIFO at selected addresses;
determining which addresses in said FIFO store primitives or nonessential data that can be deleted;
comparing a transmit address pointer in said FIFO which is incremented at said transmit clock rate to a receive address pointer in said FIFO which is incremented at said receive clock rate and, when the distance between said pointers indicates the possibility of overflow or underflow, controlling said means for transmitting so as to insert nonessential primitives or other nonessential data or to delete nonessential primitives or other nonessential data appropriately to avert either overflow or underflow.
